(19) United States
(12) Patent Application Publication
(10) Pub. No.: US 2023/0021155 A1
(43) Pub. Date: Jan. 19, 2023

(54) PICKING SYSTEM, STORAGE SYSTEM COMPRISING A PICKING SYSTEM AND METHOD OF PICKING

(71) Applicant: Autostore Technology AS, Nedre Vats (NO)

(72) Inventors: Ingvar Fagerland, Kolnes (NO); Jone Gjerde, Bryne (NO)

(73) Assignee: Autostore Technology AS, Nedre Vats (NO)

(21) Appl. No.: 17/757,651

(22) PCT Filed: Dec. 9, 2020
(86) PCT No.: PCT/EP2020/085266

§ 371 Date: Jun. 17, 2022

(30) Foreign Application Priority Data
Dec. 20, 2019 (NO) 20191511

(51) Int. Cl. B65G 1/137; B65G 1/04; B25J 9/16; B25J 9/02; B25J 19/02

(52) U.S. Cl. CPC B65G 1/1373; B65G 1/1371; B65G 1/0464; B25J 9/1697; B25J 9/026; B25J 19/023; B65G 2203/0216; B65G 2203/0233; B65G 2203/041

(57) ABSTRACT

A picking system is configured to pick items from, and put items into, storage containers. The picking system includes a picking station. The picking station includes: a picking system controller configured to receive product orders from a warehouse management system; at least one container contents handling position; a camera configured to produce an image of contents of a storage container; an image processing system in communication with the camera for processing the image produced by the camera in order to identify a position of a specific item in the storage container, and a robotic picking device. The image processing system is further in communication with a picking system controller and is adapted to inform the picking system controller of the position of the specific item. The robotic picking device is in communication with the picking system controller and is configured to, under guidance from the picking system controller, to pick said specific item from said position in the storage container. The camera and the robotic picking device are arranged to operate, at any one instance, on different containers such that the camera is producing an image and the image processing system is processing the produced image of the contents of a storage container in a first product order while the robotic picking device is handling a second storage container on the basis of an earlier image that has been produced by the camera and processed by the image processing system.

### FIELD OF THE INVENTION

The present invention relates to a picking system, an automated storage and retrieval system and a method of picking items from, and putting items into, containers at a picking station

### BACKGROUND AND PRIOR ART

FIG. 1 discloses a typical prior art automated storage and retrieval system 1 with a framework structure 100 and FIGS. 2 and 3 disclose two different prior art container handling vehicles 201,301 suitable for operating on such a system 1.

The framework structure 100 comprises upright members 102, horizontal members 103 and a storage volume comprising storage columns 105 arranged in rows between the upright members 102 and the horizontal members 103. In these storage columns 105 storage containers 106, also known as bins, are stacked one on top of one another to form stacks 107. The members 102, 103 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301 are operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301 in a first direction X across the top of the frame structure 100, and a second set of parallel rails 111 arranged perpendicular to the first set of rails 110 to guide movement of the container handling vehicles 201,301 in a second direction Y which is perpendicular to the first direction X. Containers 106 stored in the columns 105 are accessed by the container handling vehicles through access openings 112 in the rail system 108. The container handling vehicles 201,301 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supportive.

Each prior art container handling vehicle 201,301 comprises a vehicle body 201a,301a, and first and second sets of wheels 201b,301b,201c,301c which enable the lateral movement of the container handling vehicles 201,301 in the X direction and in the Y direction, respectively. In FIGS. 2 and 3 two wheels in each set are fully visible. The first set of wheels 201b,301b is arranged to engage with two adjacent rails of the first set 110 of rails, and the second set of wheels 201c,301c is arranged to engage with two adjacent rails of the second set 111 of rails. At least one of the sets of wheels 201b,301b,201c,301c can be lifted and lowered, so that the first set of wheels 201b,301b and/or the second set of wheels 201c,301c can be engaged with the respective set of rails 110, 111 at any one time.

Each prior art container handling vehicle 201,301 also comprises a lifting device (see FIG. 3) for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301 so that the position of the gripping/engaging devices with respect to the vehicle 201,301 can be adjusted in a third direction Z which is orthogonal the first direction X and the second direction Y. Parts of the gripping device of the container handling vehicle 301 are shown in FIG. 3 indicated with reference number 304. The gripping device of the container handling device 201 is located within the vehicle body 301a in FIG. 2.

Conventionally, and also for the purpose of this application, Z=1 identifies the uppermost layer of storage containers, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=10, Y=2, Z=3. The container handling vehicles 201,301 can be said to travel in layer Z=0, and each storage column 105 can be identified by its X and Y coordinates.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y and Z-direction.

Each prior art container handling vehicle 201,301 comprises a storage compartment or space for receiving and stowing a storage container 106 when transporting the storage container 106 across the rail system 108. The storage space may comprise a cavity arranged centrally within the vehicle body 201a as shown in FIG. 2 and as described in e.g. WO2015/193278A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The central cavity container handling vehicles 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference.

The term ‘lateral’ used herein may mean ‘horizontal’.

Alternatively, the central cavity container handling vehicles 101 may have a footprint which is larger than the lateral area defined by a storage column 105, e.g. as is disclosed in WO2014/090684A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail may comprise two parallel tracks.

WO2018146304, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301 can drop off storage containers 106 to be transported to an access or a transfer station, and the second port column 120 may be a dedicated pick-up port column where the container handling vehicles 201,301 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301 is instructed to retrieve the target storage container 106 from its position and transport it to the drop-off port column 119. This operation involves moving the container handling vehicle 201,301 to a location above the storage column 105 in which the target storage container 106 is positioned, retrieving the storage container 106 from the storage column 105 using the container handling vehicle's 201,301 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles.

Alternatively, or in addition, the automated storage and retrieval system 1 may have container handling vehicles specifically dedicated to the task of temporarily removing storage containers from a storage column 105. Once the target storage container 106 has been removed from the storage column 105, the temporarily removed storage containers can be repositioned into the original storage column 105. However, the removed storage containers may alternatively be relocated to other storage columns.

When a storage container 106 is to be stored in one of the columns 105, one of the container handling vehicles 201,301 is instructed to pick up the storage container 106 from the pick-up port column 120 and transport it to a location above the storage column 105 where it is to be stored. After any storage containers positioned at or above the target position within the storage column stack 107 have been removed, the container handling vehicle 201,301 positions the storage container 106 at the desired position. The removed storage containers may then be lowered back into the storage column 105, or relocated to other storage columns.

For monitoring and controlling the automated storage and retrieval system 1, e.g. monitoring and controlling the location of respective storage containers 106 within the framework structure 100, the content of each storage container 106 and the movement of the container handling vehicles 201,301 so that a desired storage container 106 can be delivered to the desired location at the desired time without the container handling vehicles 201,301 colliding with each other, the automated storage and retrieval system 1 comprises a control system 500 which typically is computerized and which typically comprises a database for keeping track of the storage containers 106.

Prior art includes WO 2017/081281 A1, which discloses a picking system where a camera is used as an onboard camera on the picker/robot arm to assist in picking/placing correctly within the bin.

Picking systems are costly and a problem addressed is to optimize the utilization of the different components of the picking system. This includes balancing the capacity used by the Automated Storage and Retrieval System (ASRS) bin delivery and optimizing the movements of the picking device.

It is an objective to of the invention to provide a picking system with increased through-put of items through picking systems.

### SUMMARY OF THE INVENTION

The present invention is set forth and characterized in the independent claims, while the dependent claims describe other characteristics of the invention.

The invention addresses how to control a picking system that includes an area divided into sub-areas (positions to pick from and pick to) where the delivery of storage containers and/or packages to these sub-areas are controlled by an Automated Storage and Retrieval System (ASRS) control system, a camera, an image processing system and a picking device that operates within the area.

It is described a picking system configured to receive instructions from a picking system controller which receives product orders from a warehouse management system, wherein the picking station further is configured to pick items from, and put items into, storage containers, wherein the picking system comprises a picking station, and wherein the picking station comprises:
at least one container contents handling position;
a camera configured to produce an image of contents of a storage container;
an image processing system in communication with the camera for processing the image produced by the camera in order to identify a position of a specific item in the storage container, the image processing system further being in communication with the picking system controller and is adapted to inform the picking system controller of the position of the specific item;
a robotic picking device, wherein the robotic picking device is in communication with the picking system controller and is configured to, under guidance from the picking system controller, to pick said specific item from said position in the storage container;
wherein the camera and the robotic picking device are arranged to operate, at any one instance, on different containers such that the camera is producing an image and the image processing system is processing the produced image of the contents of a storage container in a first product order while the robotic picking device is handling a second storage container on the basis of an earlier image that has been produced by the camera and processed by the image processing system.

This parallel operation in and/or on different containers results in that that when the robotic picking device is to pick one or more items from a storage container in a second storage container on the basis of an earlier image that has been produced by the camera and processed by the image processing system, the robotic picking device knows, in advance, the position of the specific item(s) in the storage container. Thus, according to the invention, the camera and image processing system is at least one step ahead of the robotic picking device.

The picking system provides a separation of concern by decoupling the dependency of the various sub-components involved

The image processing device may be in direct communication with the camera or indirect communication camera e.g. via the picking system controller.

The camera and image processing system may take a picture and process the image to determine the contents of a storage container which is different to the storage container being processed by the robotic picking device. Information on the position of the item(s) in the storage container is then transferred by the picking system controller to the robotic picking device such that the robotic picking device knows, in advance, the relative position of the item(s) to be picked before picking from the storage container and also which of the items that is most easily accessible. This provides for the possibility of parallel operations such that two operations are performed simultaneously.

A picking system controller (PSC) may control the picking device and the camera (including camera movements) and the image processing system.

A system controller (AC) may inform the Picking system controller (PSC) about bin deliveries (which bins are ready in which position, and possibly expected upcoming bin delivery times). Each position may have its own bin delivery plan, and its own exchange time delay.

Picking operations in a product order may be defined by an external system (warehouse management system (WMS) or Inventory management) and can be communicated to the picking system controller (PSC). A picking operation may be defined by the following information or parameters: PickFrom (bin and compartment) PickTo (bin and compartment), Quantity (number of items), and possibly additional parameters (about the item and about the picking operation such as speed operation limitation etc.). These jobs are defined independently of the actual delivery of the bins to/from the working area, because they refer to the bins'

IDs, not their physical position.

The robotic picking device can be configured to reach multiple container handling positions within the picking station.

At least a pair of container contents handling positions may be arranged next to each other (on adjacent grid rows); or one above the other etc.

The picking system may be configured to perform routing calculations, i.e. sequence of the picking jobs, for the robotic picking device and to incorporate a work flow sequence from those routing calculations into the picking device's operational sequence. This may be done in order to optimize the picking parameters and what storage containers to be picked from and place items into in order to reduce picking time and increase throughput of finished/partly-finished product orders.

Based on status from the system controller (AC) and task queue from the warehouse management system (WMS), the picking system controller (PSC) can plan, optimize and control camera movements and camera/image processing operations (sends commands to camera/image processing system).

Based on status from system controller (AC) and task queue from warehouse management system (WMS), picking system controller (PSC) plans, optimizes and controls picking operations (sends commands to picker device).

The picking station may comprise at least two container contents handling positions and the robotic picking device may be configured to move to different picking positions where it is able to pick one specific item from a first storage container positioned at a first container contents handling position and another specific item from a second storage container positioned at a second container contents handling position different from the first.

Multiple container contents handling positions, and the associated multiple picking positions, provide for the possibility that the robotic picking device can access different containers in the picking station and the control system providing larger flexibility in terms of which order the robotic picking device shall/should pick from the storage containers present in the picking station. The robotic picking device may be configured to pick from one of several container picking positions, each with a different storage container waiting to be picked.

The first storage container arranged at the first container contents handling position may be a picking container and the second storage container arranged at a second container contents handling position may be a product order consolidation container. Which of the containers that functions as picking container (s) and product order consolidation container(s), respectively, may vary and is dependent on operational parameters in terms of product order setup and similar item(s) for the different containers. In addition, the ratio of consolidation containers compared to picking containers may vary. For example, one picking container holding a specific item to be picked in many product orders and/or several items in the same product order, may have a relatively long retention time at the picking station before being exchanged with another picking container.

The camera may be arranged to produce an image of the first storage container positioned at the first container contents handling position and an image of the second storage container positioned at the second container contents handling position.

The camera can be mounted for movement above the storage containers. The camera may be mounted on a movable device. For example, the camera can be movable on a gantry arrangement above the picking station. The camera can be arranged on the same gantry as the robotic picking device, but is independently movable relative the robotic picking device.

The camera can also be arranged as part of an industrial robot. An industrial robot is typically a robot with a base mounted on a floor where a robotic arm extends from the base and to a robotic picking device in an opposite end thereof. Floor shall be understood as a base where the robot arm can be mounted, and can also be on a mezzanine floor or other elevated floor. The camera can be arranged on one or more linear guides for movement in the X, Y and Z direction. For example, if the camera is mounted at a relative large distance from the storage container that it needs to produce an image of, it may be advantageous that the camera is able to move closer to said container (i.e. in the Z direction).

The camera can be stationary and arranged to produce an image of the contents of at least one storage container when it is positioned at a storage container contents handling position.

Alternatively, the camera may be at such an elevation that it covers multiple positions within the picking station.

The picking system may comprise a section of a rail-based delivery system with perpendicular tracks in X and Y directions for supporting delivery vehicles carrying containers accessible from above. Instead of delivery vehicles operating on a delivery rail system, the picking system may comprise a conveyor arrangement for transferring containers into the picking station. The conveyor arrangement can be in different heights, and be presented for the robotic picking device in a multilevel conveyor arrangement.

The picking system may comprise a conveyor for transferring containers out from the picking station.

The robotic picking device may be a gantry-mounted robot or an industrial robot.

The image processing system may comprise means for ID recognition of a storage container's ID. This may be performed so that the image data/picker routing data is logged against an ID of a storage container. Thereby, one is assured that the correct item is picked regardless of the order of the storage container.

The storage container may be divided into two or more compartments. This may be done either to separate different items within the same container or by separating similar items within the same container for example if the operator shall only access one item.

The picking system may be arranged on a mezzanine. The mezzanine level may be arranged immediately below a top level of a storage system, e.g. only one or two storage container heights below the top level of the storage system. This reduces vertical travel time for the storage containers as they do not have to travel 10-20 container heights but rather only 1 or two levels.

The product orders can be finalized at the mezzanine level and transported on appropriate conveyors for shipment, or the storage container containing a completed, or almost completed, product order can be transported into the storage system for manual completion at an operator-operated picking station.

It is further described an automated storage and retrieval system comprising:
a rail system with perpendicular tracks in X and Y direction, wherein the storage and retrieval system comprises a plurality of remotely operated vehicles configured to move laterally on the rail system;
a picking system controller configured to receive product orders from a warehouse management system;
at least one container contents handling position;

a camera configured to produce an image of contents of a storage container;
an image processing system in communication with the camera for processing the image produced by the camera in order to identify a position of a specific item in the storage container, the image processing system further being in communication with the picking system controller and adapted to inform the picking system controller of the position of the specific item;
a robotic picking device, wherein the robotic picking device is in communication with the picking system controller and is configured to, under guidance from the picking system controller, to pick said specific item from said position in the storage container;

wherein the camera and the robotic picking device are arranged to operate, at any one instance, on different containers such that the camera is producing an image and the image processing system is processing the produced image of the contents of a storage container in a first product order while the robotic picking device is handling on the basis of an earlier image that has been produced by the camera and processed by the image processing system.

The automated storage and retrieval system renders possible that when the robotic picking device is to pick an item from a storage container in a subsequent product order, the robotic picking device knows, in advance, the position of the specific item(s) in the storage container.

The camera in the automated storage and retrieval system does not have to form part of the picking station but may be arranged at a position outside the picking station such that containers entering the picking station have already been imaged. The camera can be stationary and arranged to produce an image of the contents of at least one storage container when it is positioned at a storage container contents handling position. This camera may e.g. be arranged at, or just before entrance into the picking station such that an image is produced of all storage containers entering the picking station and the processor can decide on/set up an appropriate routing of the robotic picking device to pick from said containers. Alternatively, or additionally, each storage container feeding line (e.g. delivery rail system or conveyor) into the picking system could have its own fixed camera and the control system could pre-route based on multiple image sources.

The camera could instead be arranged within a picking station where the robotic picking device is arranged such that the position of the item(s) to be picked in each storage container is determined before the storage container enters the picking station.

The automated storage and retrieval system may further comprise a delivery vehicle arranged to receive storage containers from above and transport storage containers to the picking station, and the robotic picking device may be separate from the delivery vehicle carrying the storage container and operates independently. The system may in this embodiment comprise a section of a rail-based delivery system with perpendicular tracks in X and Y direction for supporting delivery vehicles carrying containers accessible from above. The delivery vehicle is freely movable in the X and Y directions on the delivery system within the picking station, and, when they are at the picking station, or in an area defined by the picking station, each storage container being carried by a delivery vehicle from a contents handling position of the picking station.

Instead of delivery vehicles operating on a delivery rail system, the picking system may comprise a conveyor arrangement for transferring containers into the picking station. The conveyor arrangement can be in different heights, and be presented for the robotic picking device in a multilevel conveyor arrangement. In yet another alternative, instead of delivery vehicles and/or conveyors, the storage containers can be delivered to the picking station by prior art container handling vehicle(s) comprising a lifting device for transportation of storage containers, e.g. raising a storage container from, and lowering a storage container into, a storage column, as well as horizontal transport of the storage container into a picking station. The picking station may comprise rails in the X and Y directions which are flush with the rails in the X and Y directions of the storage and retrieval system such that the container handling vehicles can enter the picking station on the same rail system. The container handling vehicle may in this alternative drop the storage container to a contents handling position within the picking station, which contents handling position may be directly below the rail system such that the robotic picking device can access the contents of the storage container relatively easily.

It is further described a method of picking items from, and putting items into, containers at a picking station under the control of a picking system controller, wherein the method comprises:
the picking system controller receiving product orders from a warehouse management system;
the picking station receiving delivery of a storage container to be picked;
producing an image of a contents of the storage container using a camera;
processing the image produced by the camera using an image processing system that is in communication with the camera to identify a position of a specific item in the storage container, the specific item being included in a product order which is to be completed, and the image processing system informing the picking system controller of the position of the specific item in the storage container;
the picking system controller determining a sequence of picking movements for a robotic picking device to execute in order to pick the specific item from the storage container based on the position determined by the image processing system;
conveying the storage container to a picking location of the picking station where it can be picked by the robotic picking device;
the picking system controller instructing the robotic picking device to execute the sequence of picking movements to pick the specific item from the storage container during handling of the product order,

wherein the camera and the robotic picking device are arranged to operate, at any one instance, on different storage containers such that the camera produces an image of the contents of a first storage container for a first product order, the image processing system processes the image and the picking system controller determines a sequence of picking movements for the robotic picking device for that first product order while the robotic picking device is handling on the basis of an earlier image that has been produced by the camera and processed by the image processing system.

The camera can also be arranged outside the picking station where the robotic picking device is arranged such that the position of the item(s) to be picked in each storage container is determined before the storage container enters the picking station.

The image can be processed by the image processing system before the storage container arrives at a picking position and the picking system controller has determined a set of picking movements before the storage container arrives to be picked.

Determination of the picking movements of the robotic picking device may be independent of the delivery of the storage containers to the picking position(s).

The picking system controller may optimize the picking movements of the robotic picking device between specific item(s) in different storage containers at different picking positions.

The image processing system may comprise an object database and the image processing system may compare the produced image with images in the object database in order to determine the position of the specific item in the storage container. The image processing system may have an object database such that it may identify different items. Thereby, one is assured that the correct item is picked regardless of the orientation of the item in the storage container. The object database is in particular suitable in situations where different kinds of items are stored in the same storage container where the object database provides input with regards to internal positioning between these different items.

The method may comprise moving the camera to a position where a storage container is present such as to produce an image of the contents of a storage container.

The image processing system may comprise means for ID recognition of the storage container(s). This may be performed so that the image data/picker routing data is logged against an ID of a storage container.

When the robotic picking device is finished picking from the target storage container, this storage container may be returned from the picking station and back into a storage column in the automated storage and retrieval system. Alternatively, the target storage container can be transported on an external conveyor for shipment.

The delivery of bins to/from the picking station is managed by a separate control system (ASRS control system or system controller (AC)).

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system;

FIG. 2 is a perspective view of a prior art container handling vehicle having a centrally arranged cavity for carrying storage containers therein;

FIG. 3 is a perspective view of a prior art container handling vehicle having a cantilever for carrying storage containers underneath;

FIG. 4A is an illustration of possible communication channels between a picking system controller and selected components forming part of a picking system;

FIG. 4B, shows an example of sequence steps carried out by a picking system controller;

FIG. 5A shows an example of a picking system with a picking station arranged on a ground floor, i.e. at the lower part of a connected storage and retrieval system, with a camera movable on a gantry above a gantry arrangement where the robotic picking device is mounted, and where the picking station comprises a double deck conveyor for bringing storage containers to and from container contents handling positions in the picking station;

FIG. 5B shows an example of a picking system with a picking station arranged on a mezzanine, i.e. the picking station is arranged at a level close to the top level of the rail system of a connected storage and retrieval system, with a camera movable on a gantry above a gantry arrangement where the robotic picking device is mounted, and where the picking station comprises a double deck conveyor for bringing storage containers to and from container contents handling positions in the picking station ;

FIG. 6A shows an example of a picking system with a picking station arranged on a mezzanine in a side view, i.e. the picking station is arranged at a level close to the top level of the rail system of a connected storage and retrieval system, with a camera movable on the same gantry arrangement as the robotic picking device is mounted, and where the picking station comprises a double deck conveyor for bringing storage containers to and from container contents handling positions in the picking station ;

FIG. 6B shows the picking system of FIG. 6A from another side, i.e. seen directly into the picking station in the longitudinal direction of the conveyors;

FIGS. 7A and 7B show an embodiment of FIG. 5B with the camera arranged on a gantry or linear guide above the robotic picking device in two different views, where FIG. 7A is a view seen directly into the picking station in the longitudinal direction of the conveyors, whereas FIG. 7B is a side view of the same;

FIGS. 8A-8D are different views of an exemplary picking system arranged on a mezzanine, where the picking station comprises a rail system which is flush with the top rail system where the container handling vehicles operate, such that the container handling vehicles can transport the storage containers from the automated storage and retrieval system directly to stationary container contents handling positions arranged at a level below the rail system of the picking station;

FIG. 9 shows an example of a picking system with a stationary camera arranged at a boundary between a volume below the top rail system and container contents handling positions on a delivery rail system;

FIG. 10A is a side view of a remotely operated delivery vehicle;

FIG. 10B is a perspective view of a remotely operated delivery vehicle having a container carrier with a compartment for holding a storage container;

FIG. 10C is a perspective view of a remotely operated delivery vehicle having a container carrier provided with conveyors;

FIG. 11 is a principle sketch of a possible setup with a picking system arranged on a mezzanine and where an external conveyor run through the picking station(s) on the mezzanine;

FIGS. 12A-12C show different examples of camera and gantry-mounted robotic picking device; and

FIG. 13 shows another example of possible setup of camera and robotic picking device.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

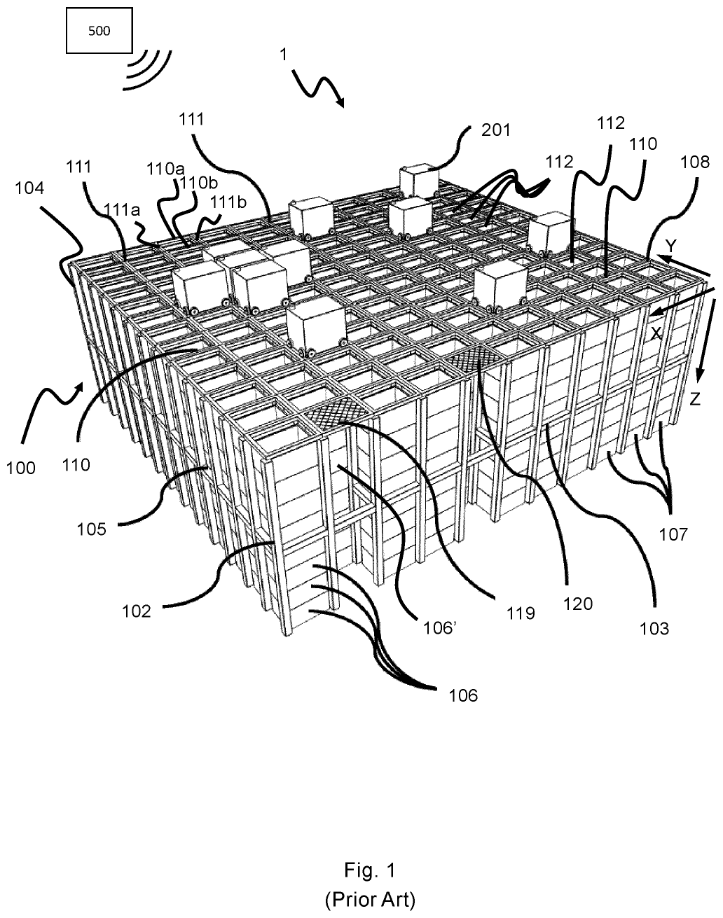

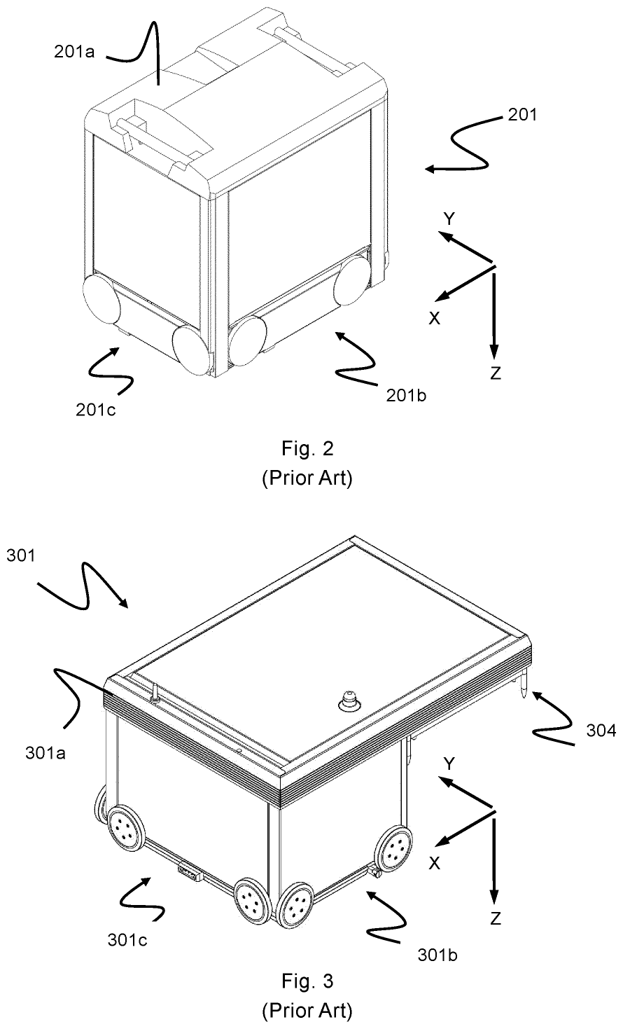

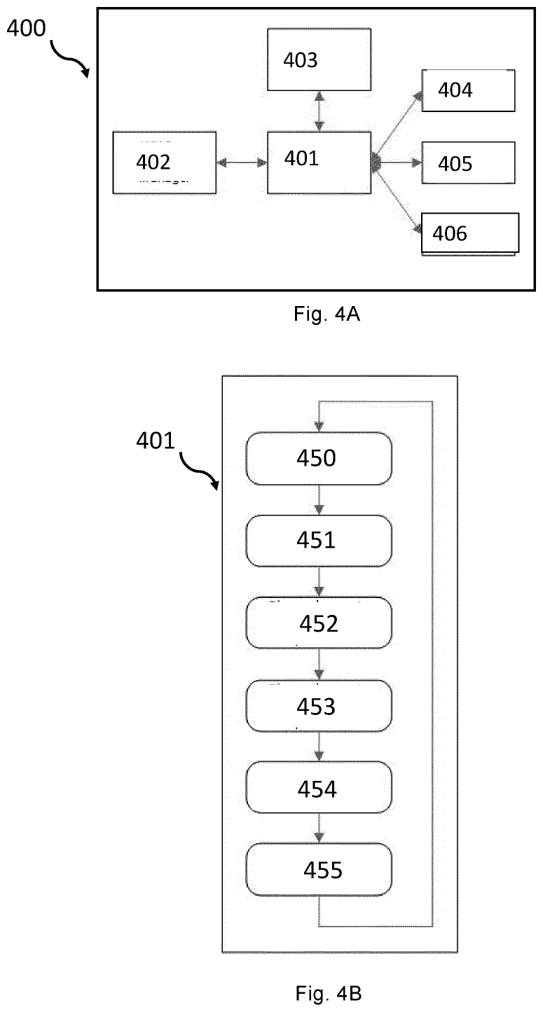

The framework structure 100 of the automated storage and retrieval system 1 is constructed in accordance with the prior art framework structure 100 described above in connection with FIGS. 1-3, i.e. a number of upright members 102 and a number of horizontal members 103, which are supported by the upright members 102, and further that the framework structure 100 comprises a first, upper rail system 108 in the X direction and Y direction.

The framework structure 100 further comprises storage compartments in the form of storage columns 105 provided between the members 102, 103, where storage containers 106 are stackable in stacks 107 within the storage columns 105.

The framework structure 100 can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

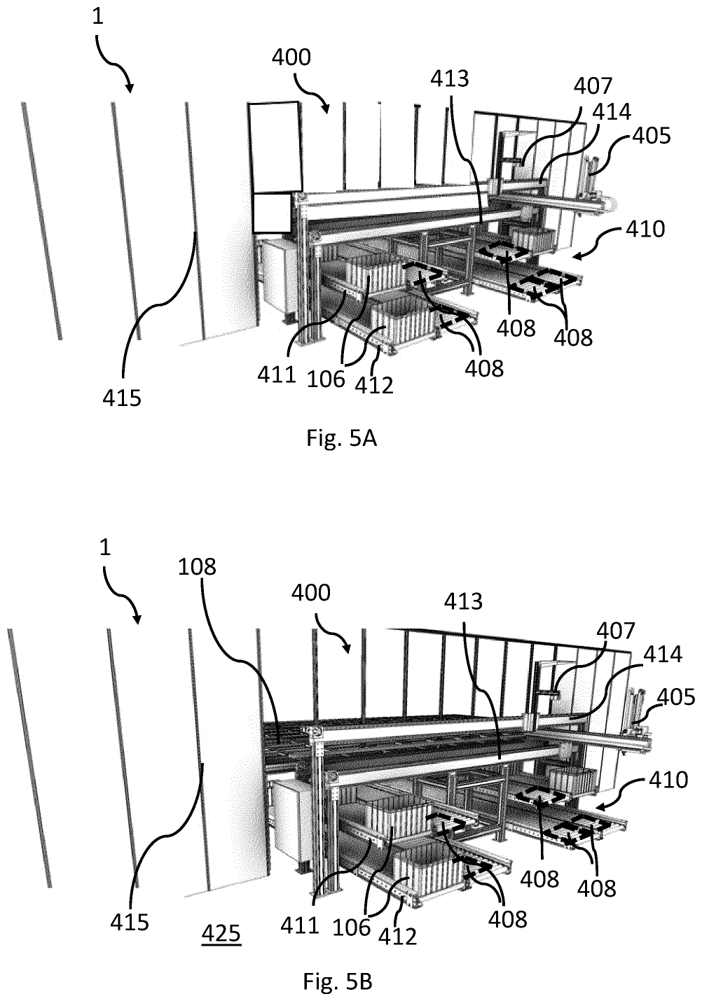

FIG. 4A is an illustration of possible communication channels in a picking system 400 between a picking system controller 401 and selected components forming part of a picking system as indicated by the arrows between the picking system controller 401 and the respective components. The picking system controller 401 is in communication with a warehouse management system 402 or an inventory management system (not shown), an ASRS control system 403, an arrangement for camera movement 404 for moving a camera connected thereto, a robotic picking device 405, and an image processing system 406.

FIG. 4B, shows an example of sequence steps carried out by a picking system controller 401. The steps may be as follows:

450: Receive picking jobs.

451: Receive storage container delivery status.

452: Plan and execute camera and image processing system operations.

453: Plan and execute robotic picking device operations.

454: Confirm picking jobs.

455: Confirm storage container completed.

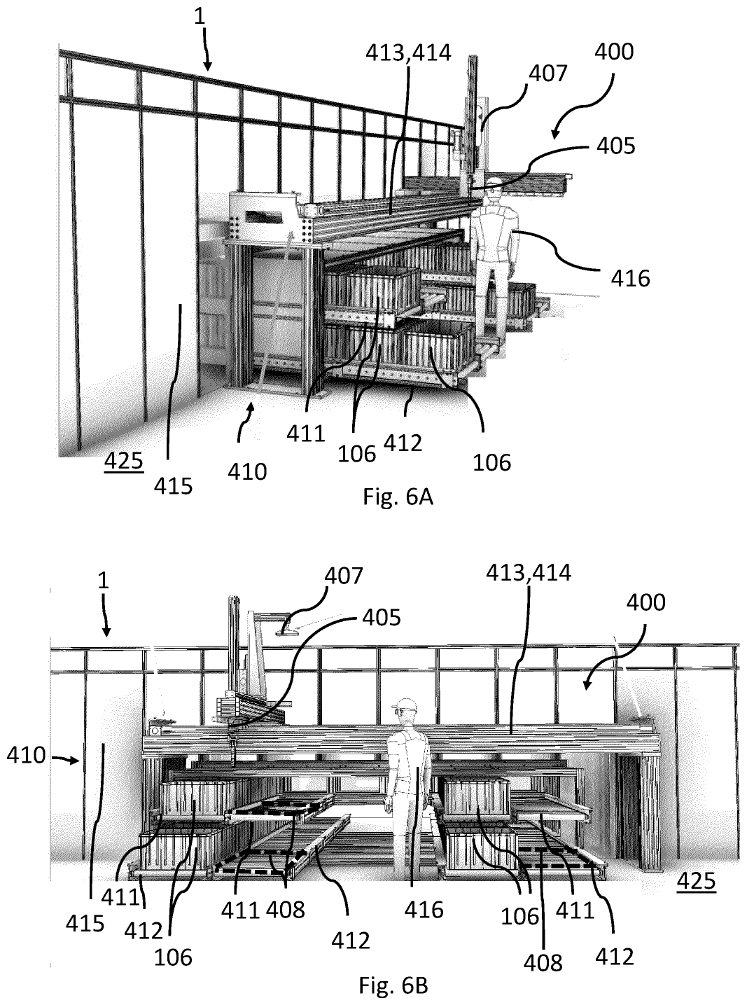

FIG. 5A shows an example of a picking system 400 with a picking station 410 arranged on a ground floor, i.e. at the lower part of a connected storage and retrieval system 1, with a camera 407 movable on a gantry 414 above a gantry arrangement 413 where the robotic picking device 405 is mounted, and where the picking station 410 comprises a double deck conveyor 411,412 for bringing storage containers 106 into and out of the picking station 410. It is a total of eight container contents handling positions 408 on the conveyors 411,412 of the picking station 410 in the example of FIG. 5A. Storage containers 106 occupy three of the container contents handling positions 408, whereas the remaining five container contents handling positions 408 on the conveyors 411,412 are unoccupied. In the disclosed embodiment, the picking station 410 comprises double deck conveyors 411,412 for bringing storage containers 106 between storage positions within the automated storage and retrieval system 1 and the container handling positions 408. The double deck conveyors 411,412 are disclosed as an upper and lower conveyor 411,412. The lower conveyors 412 are displaced equal to the size of one storage container 106 relative the upper conveyors 411. Similar, although not shown on the figure, in order to be able to put storage containers 106 onto, and retrieve storage containers 106 from, the conveyors 411, 412, the lower conveyors 412 are displaced equal to the size of one storage container 106 relative the upper conveyors 411 on the opposite ends of the conveyors 411,412. In the disclosed example the robotic picking device 405 is arranged on a gantry arrangement 413 and the camera 407 is movably arranged on a separate gantry 414 above the gantry 413 for the robotic picking device 405. In operation, the container contents handling positions 408 on the upper conveyors 411 may be for picking, whereas the container contents handling positions 408 on the lower conveyors 412 may be for consolidating picking orders. However, the setup of which of the container contents handling positions 408 used for picking and consolidation, respectively, may vary dependent on different demands. For example, if it is required to use more of the container contents handling positions 408 for picking or consolidation, this may easily be changed.

Protective panels 415 may be employed to provide a physical barrier to the storage and retrieval system 1 such that an operator may safely perform manual repair or maintenance in the picking station 410.

FIG. 5B shows an example of a picking system with a picking station 410 arranged on a mezzanine 425, i.e. the picking station 410 is arranged at a level close to the top level of the rail system 108 of a connected automated storage and retrieval system 1, with a camera 407 movable on a gantry 414 above a gantry arrangement 143 where the robotic picking device 405 is mounted. The picking station 410 comprises a double deck conveyor 411,412 for bringing storage containers 106 to and from container contents handling positions 408 in the picking station 410. The double deck conveyor 411,412 comprising upper and lower conveyors 411, 412, respectively. As can be seen in FIG. 5B, the top of the rail system 108 is visible behind the protective panel 415. The components of the picking system 400 are similar to the example of FIG. 5A and will not be repeated herein.

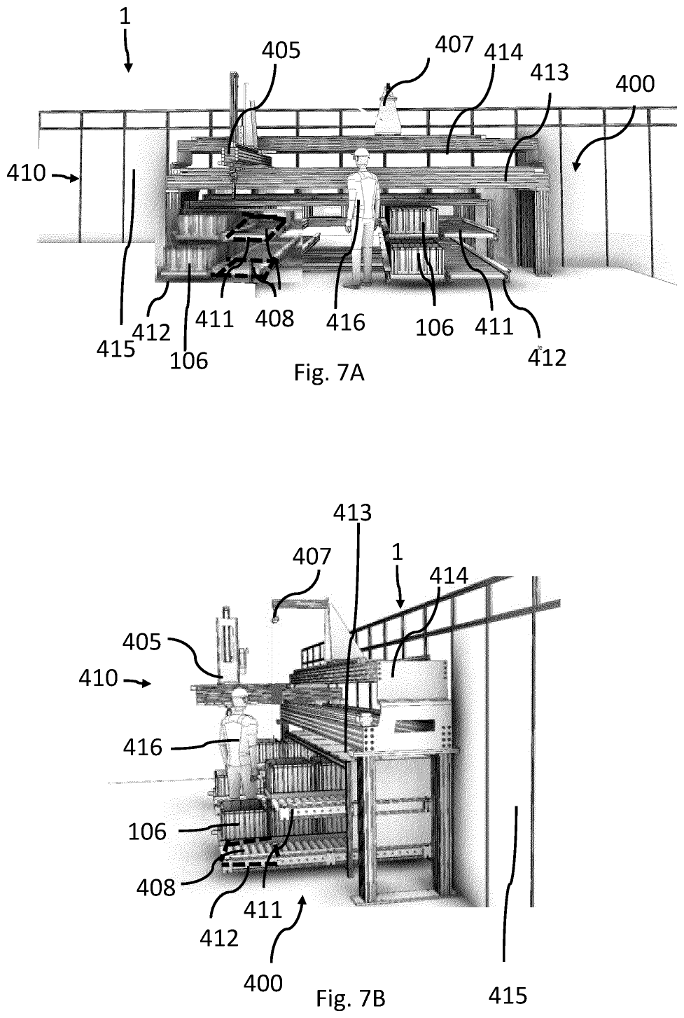

FIG. 6A shows an example of a picking system 400 with a picking station 410 arranged on a mezzanine 425 in a side view, i.e. the picking station 410 is arranged at a level close to the top level of the rail system of a connected automated storage and retrieval system 1, with a camera 407 movable on the same gantry arrangement 413 as the robotic picking device 405 is mounted, and where storage containers 106 are transported to the container contents handling positions 408 of the picking station 410 on a double deck conveyor 411,412. FIG. 6B shows the picking system 400 of FIG. 6A from another side, i.e. seen directly into the picking station 410 in the longitudinal direction of the conveyors 411, 412. The remaining components of the example in FIGS. 6A and 6B are the same as in FIGS. 5A and 5B and will not be repeated herein.

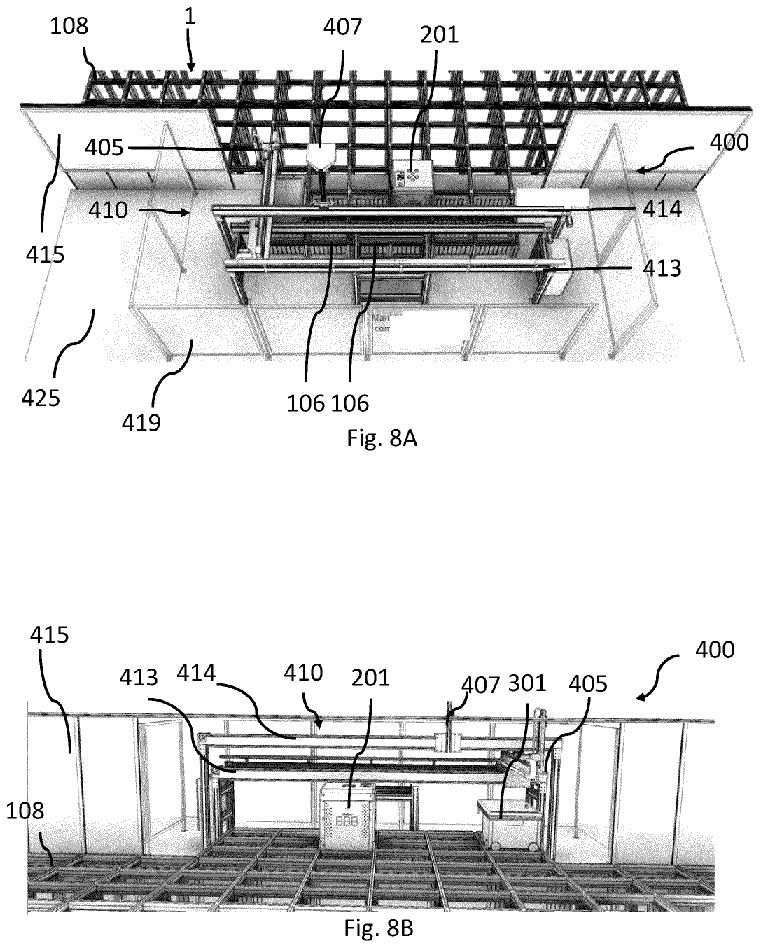

FIGS. 7A and 7B show an embodiment of FIG. 5B with the camera arranged or mounted on a gantry or linear guide above the robotic picking device 405 in two different views, where FIG. 7A is a view seen directly into the picking station 410 in the longitudinal direction of the conveyors 411,412, whereas FIG. 7B is a side view of the same.

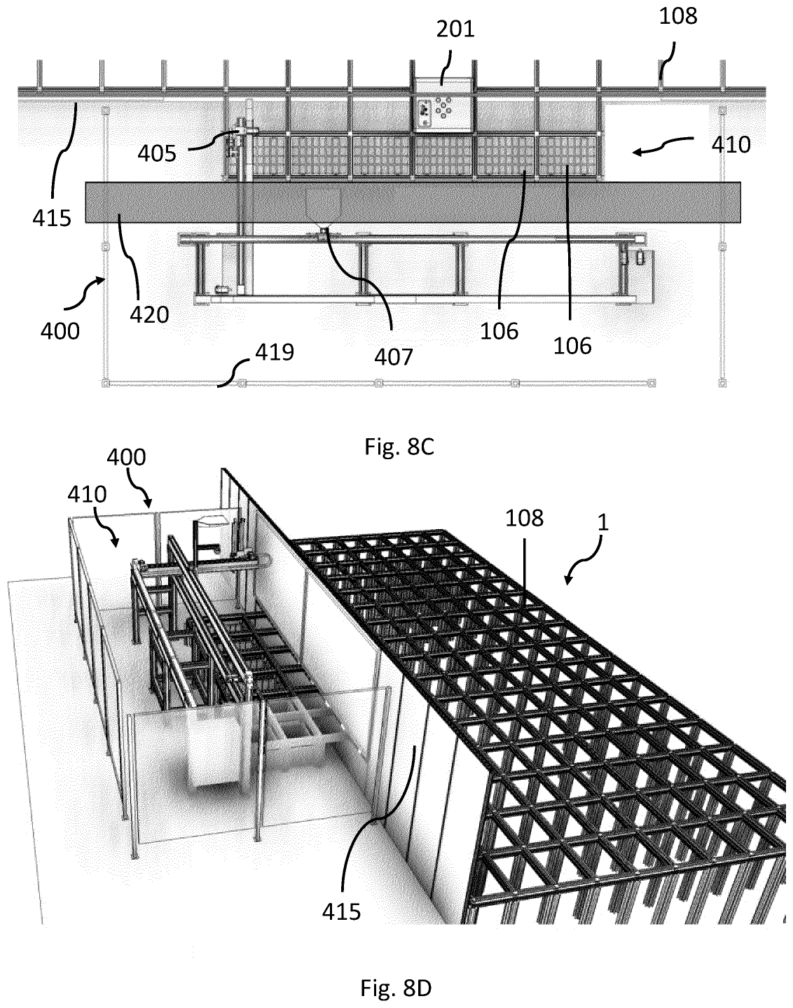

FIGS. 8A-8D are different views of an exemplary picking system 400 arranged on a mezzanine 425, where the picking station 410 comprises a rail system 108 which is flush with the top rail system 108 of an automated storage and retrieval system 1 where the container handling vehicles 201, 301 operate, such that the container handling vehicles 201, 301 can transport the storage containers 106 from the automated storage and retrieval system 1 directly to stationary container contents handling positions 408 arranged at a level below the rail system 108 of the picking system 410.

Referring to FIG. 8A which is a perspective view from above, one prior art container handling vehicle 201 is disclosed within the picking station 410 delivering and/or picking up a storage container 108 from the container contents handling position 408 below the rail system 108, such that the robotic picking device 405 can access the contents of the storage container 106. The camera 407 and robotic picking device 405 are disclosed as being mounted on a gantry 414, 413, respectively. The camera 407 is movable and can produce an image of the content of storage containers 106 placed at any of the container contents handling positions 408 in the picking station 410. In order to increase safety for any operator, picking station protective covers 419 can be arranged around the exterior of the picking station 410.

Referring to FIG. 8B, which is a side view from the top of the rail system 108 of the automated storage and retrieval system and into the picking station 410, two different of the prior art container handling vehicles 201, 301 are disclosed within the picking station 410 delivering and/or picking up a storage container 108 from the container contents handling position 408 below the rail system 108.

Referring to FIG. 8C, which is a top view of the picking station 410 in FIGS. 8A and 8B, a container handling vehicle 201 is about to enter or exit the picking station 410, i.e. the container handling vehicle 201 is about to cross the boundary formed by the protective cover 415 separating the picking station 410 and the top level of the rail system of a connected storage and retrieval system. Storage container(s) 106 placed in storage contents handling positions 408 in the picking station 410 is seen from directly above. An optional external conveyor 420, for transporting containers 106, boxes or bins with finished or completed product orders, is disclosed as running through the picking station 410.

Referring to FIG. 8D which is a perspective side view from above of the picking system 400 of FIGS. 8A-8C, an exemplary embodiment is disclosed where protective sliding doors in the protective cover 415 have been actuated such that the picking station 410 has been separated from the automated storage and retrieval system 1, forming a barrier between the picking station 410 and the top level of the rail system of a connected storage and retrieval system. This option may be advantageous in situations where maintenance or repair is required on one of the components of the picking system 400 or picking station 410 without necessitate shutdown of the operation of the container handling vehicles 201, 301 operating on the top rail system 108 in the connected automated storage and retrieval system.

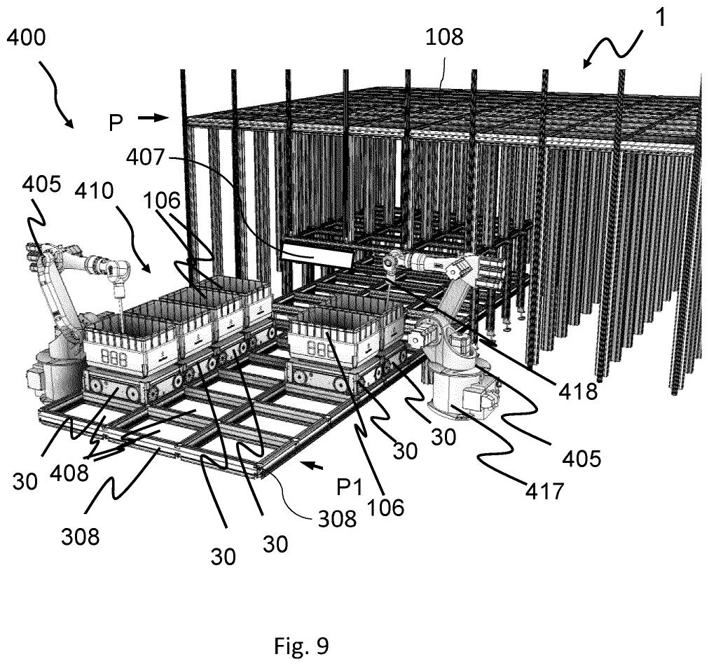

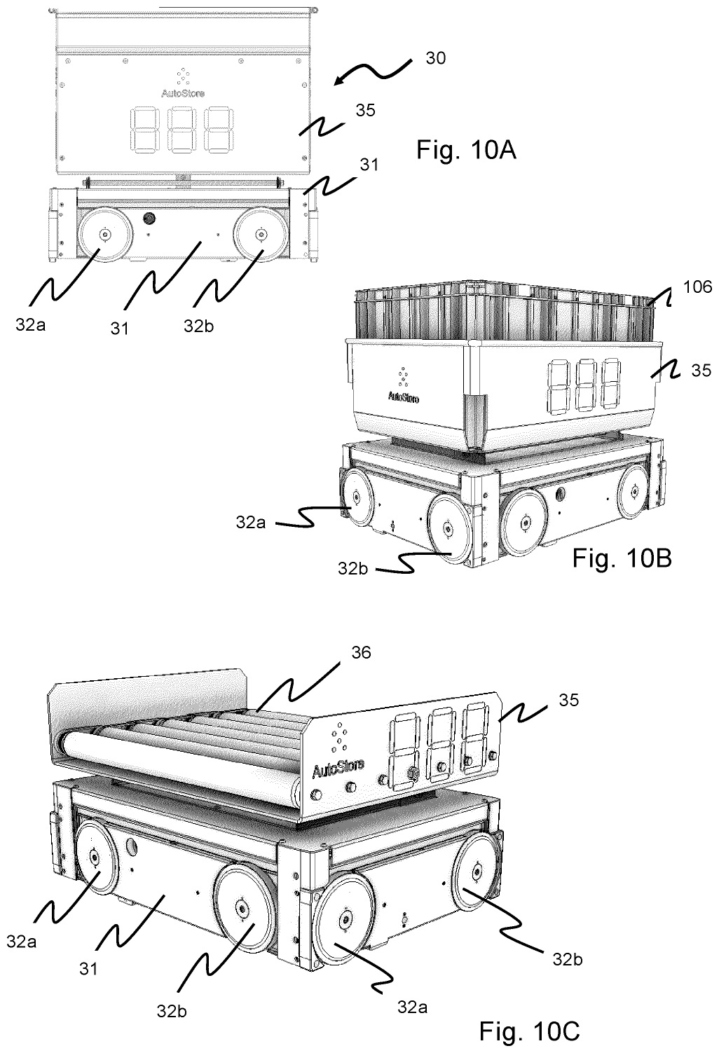

FIG. 9 shows an example of a picking system 410 with a stationary camera 407 arranged at a boundary between a volume below the top rail system 108 and container contents handling positions 408. The robotic picking device is in the form of two industrial robots 405. The storage containers 106 are transferred between the volume below the top rail system 108 and the container contents handling positions 408 of the picking station 410 by means of delivery vehicles 30 operating on a delivery rail system 308. The delivery rail system 308 extends into the volume immediately below the top rail system 108 (at horizontal plane P in FIG. 9) where container handling vehicles (not shown in FIG. 9) operate such that storage containers 106 can be transferred directly between the container handling vehicles and the delivery vehicles 30. The delivery vehicles 30 are further described in FIGS. 10A-10C. In the example of FIG. 9, due to the arrangement of two industrial robots 405 positioned spaced apart covering different parts of the delivery rail system 308, all positions on the part of the delivery rail system 308 outside the volume immediately below the top rail system 108. may serve as container contents handling positions 408. The industrial robots 405 are disclosed with a base 417 mounted on a floor where a robotic arm extends from the base and to a picker 418 in an opposite end thereof.

Each of the robotic picking devices 405 is disclosed as having one robot arm and are configured for picking and placing product items or goods into the storage containers 106 in the container contents handling positions 408 and possibly place the picked goods or product items into transport container(s) (not shown in FIG. 9) arranged at a location outside the delivery rail system 308 and picking station 410 for further transport. Although the robotic picking devices 405 are disclosed with one robot arm, it is clear that one robotic picking device 405 may have more than one robot arm, for example, two, three, four, five, . . . , nine, ten arms and so on.

The robotic picking devices 405 can be operated to move in the XYZ directions thereby allowing access to storage containers 106 at different container contents handling positions 408 within the delivery rail system 308, and transfer the at least one product item between the storage container 106 and a location outside the delivery rail system 308. The length of the robot arm(s) of the robotic operator(s) 405 as well as other features of the robot arm(s) can be adjusted dependent on the demands in the specific projects such as number of delivery vehicles 30, size of the delivery rail system 308, number of robotic operators 405 etc.

FIG. 10A shows a remotely operated delivery vehicle 30, hereinafter referred to as a delivery vehicle 30.

The delivery vehicle 30 is configured for transport of one or more storage containers 106 on a delivery rail system 308.

The delivery vehicle 30 may be configured for transport of only one storage container 106, or may be configured for transport of more than one storage container 106.

With reference to FIGS. 10A-10C, said delivery vehicle 30 comprises; a vehicle body 31, rolling devices 32 connected to the vehicle body 31, rolling device motors (not shown) for driving the rolling devices 32 in a horizontal plane P1 (see FIG. 9), and a power source 43 connected to the rolling device motor(s). The power source 43 should provide sufficient power to the rolling device motor to propel the rolling device 32 over a set route from inside the storage and retrieval system 1 and to the picking station 410.

If used on a delivery rail system 308 one of both sets of wheels 32a, 32b of the rolling device 32 should be lifted and lowered so that the first set of wheels 32a and/or the second set of wheels 32b can be engaged with the respective set of rails provided on the delivery rail system 308 any one time.

The delivery vehicle 30 may further comprise a container carrier 35 mounted above the vehicle body 31. The container carrier 35 should be configured to receive the storage container 106 onto or within the container carrier 35 such that the storage container 106 is hindered to move relative to the container carrier in the horizontal direction.

The container carrier 35 may comprise a container supporting device supporting the storage container 106 from below.

In FIG. 10A the container carrier 35 is disclosed in the form of a storage container receiving compartment having a bottom/base and side walls. The volume of the compartment is in this exemplary configuration such that it may receive and contain the entire horizontal extent of the storage container and at least a part of the vertical extent of the storage container. FIG. 10A show an example of container carriers 35 containing an entire storage container 106 and FIG. 10B shows an alternative container carrier 35 containing a part of the storage container 106, whereas FIG. 10C shows another alternative where the delivery vehicle 30 has a container carrier 35 provided with conveyors 36.

The particular configuration of the container carrier 35 disclosed in FIG. 10A allows the delivery vehicle 30 to transport a storage container 106 having different heights.

Note that the size of the compartment within the container carrier 35 may easily be adapted for receiving and supporting a multiple number of storage containers 106 in one operation.

FIG. 10B shows another alternative of a remotely operated delivery vehicle 30. Similar to the container carrier 35 described above, the container carrier 35 of this configuration is a container supporting device for supporting the storage container 106 from below.

The container supporting device hence comprises a base plate provided with side walls along the outer circumference or periphery of the base plate, thereby defining a compartment. The horizontal extent of the compartment is adapted to be large enough to receive one or more storage containers 106 and small enough to substantially hinder movements of the one or more storage containers 106 when inserted. However, in contrast to the exemplary configuration of the delivery vehicle 30 shown in FIG. 10A, the one or more side wall(s) of the container supporting device in FIG. 10B has a vertical height less than the vertical height of each storage container 106. In fact, in order to achieve the purpose of the side walls of the container carrier 35 (to substantially prevent horizontal movement when inserted) it is sufficient with only a small vertical protrusion upwards from the base plate, for example less than 5% of the height of the side walls of the storage container 106.

FIG. 10C shows yet another exemplary configuration of the remotely operated delivery vehicle 30. In this configuration the container carrier 35 comprises a base plate, a conveyor 36 with rollers arranged on the base plate and two parallel side walls protruding upwards from the base plate. The rolling device 32 and the vehicle body 31 are the same as or similar to the rolling device 32 and the vehicle body 31 described above in connection with FIGS. 10A and 10B.

The conveyor 36 may be set up by a plurality of parallel oriented rollers having a common longitudinal direction perpendicular to the two side walls. In this way the rollers allow one or more storage containers 106 to be shifted into or off the container carrier 35 while being guided by the side walls. The conveyor may be connected to a conveyor motor (not shown) driving rotation of one or more of the rollers.

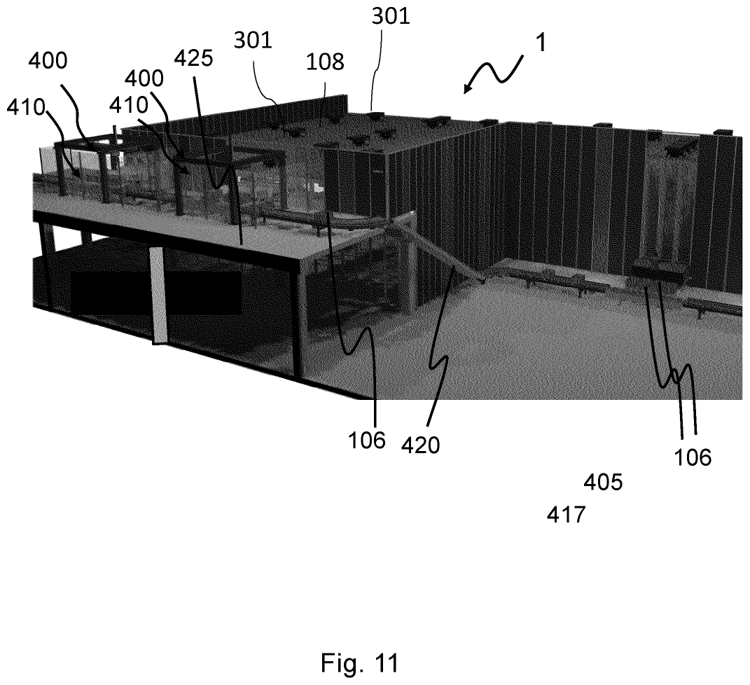

FIG. 11 is a principle sketch of a possible setup with a picking system 400 arranged on a mezzanine 425 and where an external conveyor 420 run through the picking stations 410 on the mezzanine 425 for transporting containers 106, bins or boxes containing completed/finished product orders to shipment.

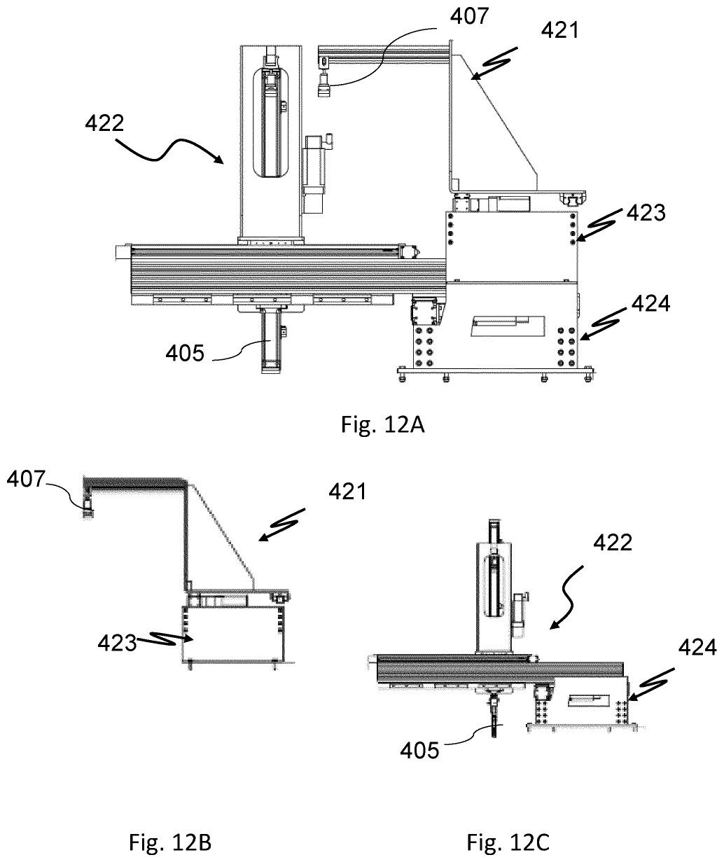

FIGS. 12A-12C show different examples of camera 407 and gantry-mounted robotic picking device 405, where FIG. 12A shows a combination of a camera module 421 with a camera 407 and a robotic picking device module 422 with a robotic picking device 405 when connected in the same structure, FIG. 12B shows the camera module 421 of FIG. 12A separated from the robotic picking device module 422, and FIG. 12C shows the robotic picking device module 422 of FIG. 12A separated from the camera module 421. Both the camera module 421 and the robotic picking device module 422 comprises a base 423, 424, respectively. The respective bases 423, 424 may be connectable to a gantry arrangement (not shown) and may comprise any necessary driving means, guiding means, motor(s), control system etc. for operating the camera 407 and robotic picking device 405. The bases 423, 423 may comprise means for movable connection relative one or more beams in the respective gantry arrangements 413, 414 (see e.g. FIGS. 5-7).

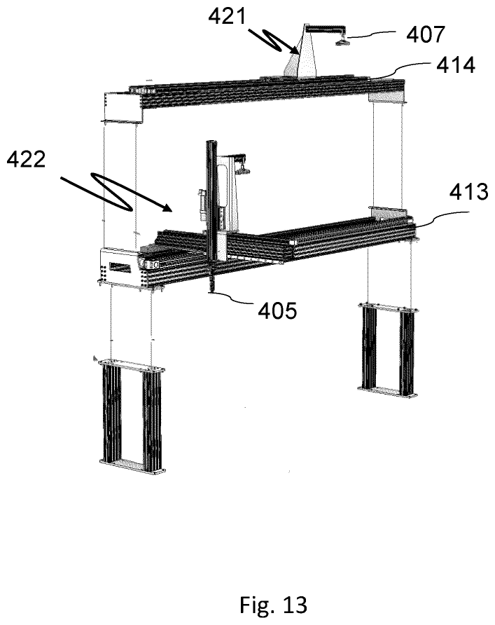

FIG. 13 shows another example of possible setups of camera 407 and robotic picking devices 405. Compared to the example of FIG. 12A, the camera module 423 with camera 407 is arranged in the same vertical plane and in a larger distance from the robotic picking device module 423 with robotic picking device 405. The robotic picking device module 422 is mounted on a gantry arrangement 413 while the camera module 421 is mounted on a gantry 414.

Motor(s), control system and other equipment and components necessary forming part of the system in order to be able to move and operate the robotic picking device 405 and camera 407, will be known to the skilled person and are not described in more detail herein.

Common to all of the disclosed embodiments, typically, once a product order from a storage container 106 at a container inventory handling position 408 serving as a picking position is finished, the storage container 106 is returned to a storage position within the storage and retrieval system and a new storage container 106 with items for the same, or another, product order, is transported from a storage position in the storage and retrieval system 1 to the container contents handling position 408. Once a product order in a storage container 106 (or box or bin) used for consolidation is finished, or at least partly finished with product items that can be picked by the robotic picking device 405, it is typically either removed from the container contents inventory position 408 to a conveyor (see FIG. 11) or similar external of the storage and retrieval system 1 or returned to the storage and retrieval system 1 by a conveyor (see e.g. FIGS. 5-7) or by a delivery vehicle 30 (see e.g. FIG. 9) for finishing at a manual (i.e. operator operated) picking station for product items not suitable for picking by the robotic picking device 405.

Furthermore, also common to all of the different robotic picking devices 405 described above, they may be provided with suitable gripping device(s), as well as any necessary auxiliary equipment such as camera, light, distance sensors etc., dependent on demands in the specific project and size and shape of the product items. Such equipment will be known to the skilled person and is not further specified herein. Furthermore, the means needed for mounting the robotic picking device(s) 405 to the gantry arrangement 413 may be any means providing the desired function of movement in the XYZ-directions relative the underlying delivery rail system 50, which means are known to the skilled person and will not be further described herein. Similarly, any fastening necessary for the floor base mounted robotic picking device 405, or base on delivery rail 308, will be known to the skilled person, i.e. any means providing necessary stability and or facilitates the possibility of rotational movement of the robotic operator 405 relative the floor base or delivery rail base (not shown).

In the preceding description, various aspects of the delivery vehicle and the automated storage and retrieval system according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

### LIST OF REFERENCE NUMBERS

30 Prior art automated storage and retrieval system
30 Delivery vehicle
31 Vehicle body
32 Rolling device
32a First set of wheels
32b Second set of wheels
35 Container carrier
36 Conveyor
100 Framework structure
102 Upright members of framework structure
103 Horizontal members of framework structure
104 Storage grid
105 Storage column
106 Storage container
106′ Particular position of storage container
107 Stack
108 Top Rail system
110 Parallel rails in first direction (X)
110a First rail in first direction (X)
110b Second rail in first direction (X)
111 Parallel rail in second direction (Y)
111a First rail of second direction (Y)
111b Second rail of second direction (Y)
112 Access opening
119 First port column
120 Second port column
201 Prior art storage container vehicle
201a Vehicle body of the storage container vehicle 201
201b Drive means/wheel arrangement, first direction (X)
201c Drive means/wheel arrangement, second direction (Y)
301 Prior art cantilever storage container vehicle
301a Vehicle body of the storage container vehicle 301
301b Drive means in first direction (X)
301c Drive means in second direction (Y)
304 Gripping device
308 Delivery rail system
400 Picking system
401 Picking system controller (PSC)
402 Warehouse management system (WMS)
403 ASRS (automated storage and retrieval system) control system
404 Camera movement
405 Robotic picking device
406 Image processing system
407 Camera
408 Container contents handling position
410 Picking station
411 Upper conveyor
412 Lower conveyor
413 Gantry for robotic picking device
414 Gantry for camera
415 Protective cover
416 Human/manual operator
417 Robot base
418 picker
419 Picking station protective cover
420 External conveyor
421 Camera module
422 Robotic picking device module
423 Base camera module
424 Base robotic picking device module
425 Mezzanine
500 Control system
P Horizontal plane where container handling vehicles operate
P1 Horizontal plane where delivery vehicles operate
X First direction
Y Second direction
Z Third direction

1. Picking system configured to pick items from, and put items into, storage containers, wherein the picking system comprises a picking station, and wherein the picking station comprises:
a picking system controller configured to receive product orders from a warehouse management system;
at least one container contents handling position;
a camera configured to produce an image of contents of a storage container;
an image processing system in communication with the camera for processing the image produced by the camera in order to identify a position of a specific item in the storage container, the image processing system further being in communication with a picking system controller and is adapted to inform the picking system controller of the position of the specific item;
a robotic picking device, wherein the robotic picking device is in communication with the picking system controller and is configured to, under guidance from the picking system controller, to pick said specific item from said position in the storage container;
wherein the camera and the robotic picking device are arranged to operate, at any one instance, on different containers such that the camera is producing an image and the image processing system is processing the produced image of the contents of a storage container in a first product order while the robotic picking device is handling a second storage container on the basis of an earlier image that has been produced by the camera and processed by the image processing system.

2. The picking system according to claim 1, wherein the picking system controller is configured to perform routing calculations for the robotic picking device and to incorporate the work flow sequence from those routing calculations into the picking device's operational sequence.

3. The picking system according to claim 1, wherein the picking station comprises at least two container contents handling positions and wherein the robotic picking device is configured to move to different picking positions where it is able to pick one specific item from a first storage container positioned at a first container contents handling position and another specific item from a second storage container positioned at a second container contents handling position different from the first.

4. The picking system according to claim 1, wherein the picking station comprises at least two container contents handling positions and wherein the robotic picking device is configured to move to different picking positions where it is able to pick one specific item from a first storage container arranged at a first container contents handling position, the first storage container being a picking container, and the second storage container arranged at a second container contents handling position, the second storage container being a product order consolidation container.

5. The picking system according to claim 3, wherein the camera is arranged to produce an image of the first storage container positioned at the first container contents handling position and an image of the second storage container positioned at the second container contents handling position.

6. The picking system according to claim 5, wherein the camera is mounted for movement above the storage containers.

7. The picking system according to claim 1, wherein the camera is stationary and arranged to produce an image of the contents of at least one storage container when it is positioned at a container contents handling position.

8. The picking system according to claim 1, wherein the picking system comprises a section of a rail-based delivery system with perpendicular tracks in X and Y direction for supporting delivery vehicles carrying containers accessible from above.

9. The picking system according to claim 1, wherein the robotic picking device is a gantry-mounted robot or an industrial robot.

10. The picking system according to claim 1, wherein the image processing system comprises means for ID recognition of a storage container's ID.

11. The picking system according to claim 1, wherein the picking system is arranged on a mezzanine.

12. An automated storage and retrieval system comprising:
a rail system with perpendicular tracks in X and Y direction, wherein the automated storage and retrieval system comprises a plurality of remotely operated vehicles configured to move laterally on the rail system;
a picking system controller configured to receive product orders from a warehouse management system;
at least one container contents handling position;
a camera configured to produce an image of contents of a storage container;
an image processing system in communication with the camera for processing the image produced by the camera in order to identify a position of a specific item in the storage container, the image processing system further being in communication with the picking system controller and is adapted to inform the picking system controller of the position of the specific item;
a robotic picking device, wherein the robotic picking device is in communication with the picking system controller and is configured to, under guidance from the picking system controller, to pick said specific item from said position in the storage container;
wherein the camera and the robotic picking device are arranged to operate, at any one instance, on different containers such that the camera is producing an image and the image processing system is processing the produced image of the contents of a storage container in a first product order while the robotic picking device is handling a second storage container on the basis of an earlier image that has been produced by the camera and processed by the image processing system.

13. The automated storage and retrieval system according to claim 12, wherein the camera is arranged within a picking station where the robotic picking device is arranged such that the position of the item(s) to be picked in each storage container is determined before the storage container enters the picking station.

14. The automated storage and retrieval system according to claim 12, further comprising a delivery vehicle arranged to receive storage containers from above and transport storage containers to the picking station, and wherein the robotic picking device is separate from the delivery vehicle carrying the storage container and operates independently.

15. A method of picking items from, and putting items into, containers at a picking station under the control of a picking system controller, wherein the method comprises:
the picking system controller receiving product orders from a warehouse management system;
the picking station receiving delivery of a storage container to be picked;
producing an image of a contents of the storage container using a camera;
processing the image produced by the camera using an image processing system that is in communication with the camera to identify a position of a specific item in the storage container, the specific item being included in a product order which is to be completed, and the image processing system informing the picking system controller of the position of the specific item in the storage container;
the picking system controller determining a sequence of picking movements for a robotic picking device to execute in order to pick the specific item from the storage container based on the position determined by the image processing system;
conveying the storage container to a picking location of the picking station where it can be picked by the robotic picking device;
the picking system controller instructing the robotic picking device to execute the sequence of picking movements to pick the specific item from the storage container during handling of the product order,
wherein the camera and the robotic picking device are arranged to operate, at any one instance, on different storage containers such that the camera produces an image of the contents of a first storage container for a first product order, the image processing system processes the image and the picking system controller determines a sequence of picking movements for the robotic picking device for that first product order while the robotic picking device is handling a second storage container on the basis of an earlier image that has been produced by the camera and processed by the image processing system.

16. The method according to claim 15, wherein the image is processed by the image processing system before the storage container arrives at a picking position and the picking system controller has determined a set of picking movements before the storage container arrives to be picked.

17. The method according to claim 15, wherein the determination of the picking movements of the robotic picking device is independent of the delivery of the storage containers to the picking position(s).

18. The method according to claim 16, wherein the picking system controller optimizes the picking movements of the robotic picking device between specific item(s) in different storage containers at different container contents handling positions.

19. The method according to claim 16, wherein the image processing system comprises an object database and wherein the image processing system compares the produced image with images in the object database in order to determine the position of the specific item in the storage container.

20. The method according to claim 16, comprising moving the camera to a position where a storage container is present such as to produce an image of the contents of a storage container.

21. The method according to claim 16, wherein the image processing system comprises means for ID recognition of the storage container(s).
